(19) United States
(12) Patent Application Publication
(10) Pub. No.: US 2004/0248068 A1
(43) Pub. Date: Dec. 9, 2004

(54) Audio-visual method of teaching a foreign language

(76) Inventor: Leon Davidovich, Provo, UT (US)

Correspondence Address: Angus C. Fox, III, 4093 N. Imperial Way, Provo, UT, 84604-5386, US

(21) Appl. No.: 10/455,595

(22) Filed: Jun. 5, 2003

(51) Int. Cl. G09B 19/06; G09B 19/08

(52) U.S. Cl. 434/157; 434/156; 434/185; 434/307 R

(57) ABSTRACT

An audio-visual method of learning a foreign language, which can be practiced using a video projection screen with concomitant audio, or a television includes the steps of: showing the program (in a foreign language) in its original form; showing either a sequence of frozen scenes or a sequence of short program segments, each frozen scene or segment including a single statement by one of the program participants, along with a transcription and a translation of the statement; reshowing the program in its original form; reshowing the sequence of frozen scenes or short program segments, along with only a transcription of the associated statement; and reshowing the program in its original form. Statements by program participants may be shown as subtitles or as dialog balloons such as those used in comic books. Short program segments may end with a frozen frame, which includes the translation and/or transcription.

### BACKGROUND OF THE INVENTION

1. Field of the Invention

This invention relates to methods of teaching foreign languages and, more particularly, to audio-visual methods utilizing a television having replay capability.

2. Description of the Prior Art

Human beings appear to be genetically programmed to learn languages. From the time a human embryo has developed hearing capability, it begins to recognize the sounds in the uterine environment. The process of language learning progresses rapidly after birth, and by the time a child has reached the age of a year, it has often begun to utter simple words. By the age of two, a child is typically able to speaks in simple, but complete, sentences. By the age of four or five, the child has mastered the basics of the language, including grammar, although vocabulary, in most cases, continues to expand dramatically at least for another ten years.

Over the last forty years, there has been a realization that the best language learning process mimics the natural one to which children are subjected. There is a nearly constant audio-visual interaction with other individuals. There is also a constant incentive to improve one's language skills, as it provides greater opportunity to communicate with others and allows the speaker to better express his perceived needs to those who care for him.

One of the major drawbacks to conventional language learning is that it is tedious and, for many, downright boring.

### SUMMARY OF THE INVENTION

This invention provides a new audio-visual method for learning a foreign language. The preferred embodiment of the method may be implemented using any movie, program or series (hereinafter, generally program) relating to any topic that can be shown on any video screen having concomitant audio, such as a computer display screen or a television. It is, of course, understood that the program is presented to one or more viewing individuals, or students, who desire to learn the foreign language.

The method is implemented using the following steps: 1) showing, on a video screen at least a portion of a program, including both motion picture and audio components, in its original form (in the foreign language to be learned); 2) showing a sequence of short program segments or a sequence of frozen scenes, each segment or frozen scene including a single spoken phrase by one of the program participants, along with a transcription and a translation of the statement; 3) reshowing the program in its original form; 4) reshowing the sequence of short program segments or frozen scenes or short program segments, along with only a transcription of the associated statement; and 5) reshowing the program in its original form.

Statements by program participants may be shown as subtitles or as dialog balloons such as those used in comic books. It is intended that the short program segments end with a frozen frame, which includes the translation and/or transcription. The transcription can be real time. That is, words are placed on the screen as they are spoken. As the syntax of one language is seldom identical to that of another, the translation may be shown when the phrase is completely spoken, or it may be shown at approximately the same rate as the transcription occurs. In the latter case, the viewer should be counseled that there is not necessarily a word by word correspondence between the transcription and the translation. In order to enhance the learning experience, baroque background music by composers such as Handel, Bach, Corelli, Pachelbel, Vivaldi and Teleman may be played during the presentation of the entire process or, alternatively, during the presentation of frozen scenes or short program segment.

In a case where audio is available without an accompanying motion picture sequence, the method is implemented on a television using the following steps: 1) presenting the lecture in its original form (in the foreign language to be learned); 2) presenting a sequence of phrases, each phrase being presented in spoken form and having both an accompanying textual transcription thereof and a corresponding textual translation that are shown for between 4 and 10 seconds; 3) re-presenting the lecture in its original form; 4) presenting again the sequence of phrases in spoken form accompanied by a textual transcription thereof; and 5) re-presenting the lecture in its original form.

The audio-visual method described above may be supplemented with translation, grammar and vocabulary drills, which are based on the contents of the program.

Alternatively or supplementally, a workbook may be provided for use by the viewer/listener, which provides translation, grammar and vocabulary drills which are related to the program, and which are to be completed in writing by the viewer/listener.

The primary focus of the invention is to make foreign language learning enjoyable and less of a chore, using the plethora of audio-visual presentations that are readily available in the form of movies, soap operas, news and educational programs, and even cartoons. The original purpose of the presentation is unimportant, so long as it holds the interest of the viewer.

### BRIEF DESCRIPTION OF THE DRAWINGS

The invention will be described with reference to the drawings. Each of the drawings is representative of a single screen shot during which a phrase of dialog is presented by a single person. These particular drawings are taken from a popular Mexican soap opera in which only dialog is heard. Baroque background music is played during the presentation.

FIG. 1 is a screen shot of a young woman who is responding to a question posed to her by her father;

FIG. 2 is the same screen shot shown in FIG. 1, but with a transcription line in the original Spanish and a translation line in English added;

FIG. 3 is a screen shot of the young woman of FIG. 1, as she continues her response to the question posed to her by her father; and

FIG. 4 is the same screen shot shown in FIG. 3, but with a transcription line in the original Spanish and a translation line in English added.

### DESCRIPTION OF THE PREFERRED EMBODIMENT

This invention provides a new audio-visual method for learning a foreign language. The preferred embodiment of the method may be implemented using any movie, program or series (hereinafter, generally program) relating to any topic that can be shown on any video screen having concomitant audio, such as a computer having both display and audio capability or a television. The new learning method will now be described with reference to the attached drawing figures. Some imagination is required, as it is impossible to accurately depict a motion picture sequence on paper.

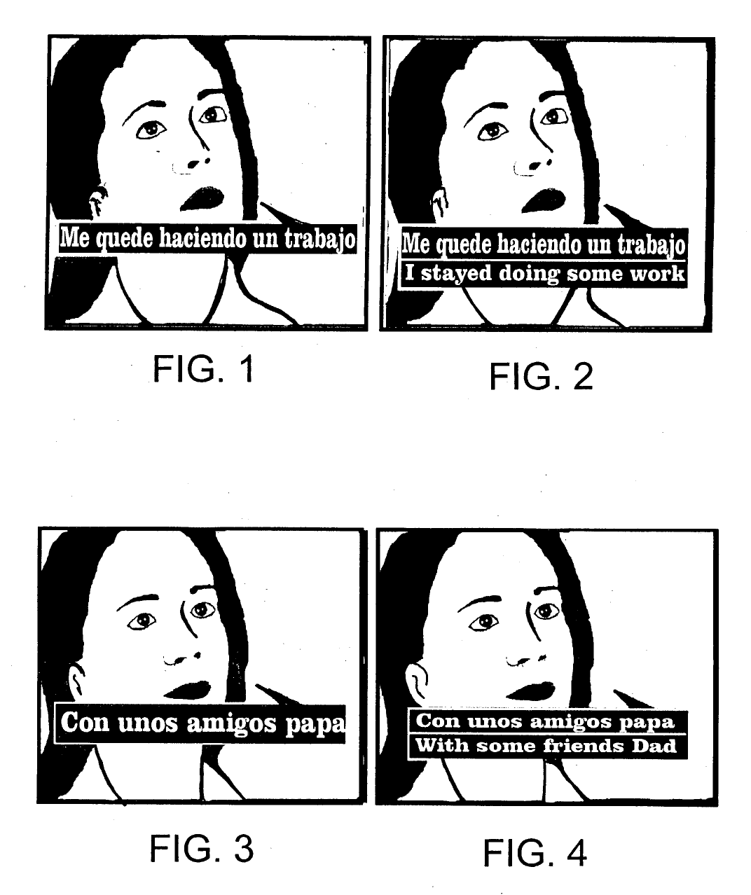

The method is implemented using a series of steps. Firstly, at least a portioin of a program, including both motion picture and audio components, is shown to at least one student in its original form (in the foreign language to be learned) on a video screen with concomitant audio. The screen shots of the present program represent only a small portion of a soap opera series that is presented on television in Mexico. An entire episode of the soap opera, or a portion thereof, is shown without editing, accompanying text, or comment. Each episode lasts about half and hour, and consists of motion picture filming with accompanying audio script provided by the various actors and actresses. Secondly, a series of short program segments or a sequence of frozen scenes, each segment or frozen scene including a single spoken phrase by one of the program participants, along with a transcription and a translation of the statement, is shown. FIGS. 2 and 4 are representative of this step. Thirdly, the program is shown again in its original form. Fourthly, the sequence of short program segments or frozen scenes is shown again. However, this time, only a transcription of the associated statement is provided. FIGS. 1 and 3 are representative of this step. Finally, the program is shown a third time in its original form.

Statements by program participants may be shown as subtitles or as dialog balloons such as those used in comic books. It is intended that the short program segments end with a frozen frame, which includes the translation and/or transcription. The transcription can be real time. That is, words are placed on the screen as they are spoken. As the syntax of one language is seldom identical to that of another, the translation may be shown when the phrase is completely spoken, or it may be shown at approximately the same rate as the transcription occurs. In the latter case, the viewer should be counseled that there is not necessarily a word by word correspondence between the transcription and the translation. In order to enhance the learning experience, baroque background music by composers such as Handel, Bach, Corelli, Pachelbel, Vivaldi and Teleman may be played during the presentation of the entire process or, alternatively, during the presentation of frozen scenes or short program segment.

In a case where audio is available without an accompanying motion picture sequence, the method is implemented on a television using the following steps. First, the lecture is presented in its original form (in the foreign language to be learned). Secondly, a sequence of individual phrases is presented, each phrase being presented in spoken form and having both an accompanying textual transcription thereof and a corresponding textual translation that are shown on the screen for between 4 and 10 seconds. Thirdly, the lecture is presented in its original form. Fourthly, the sequence of phrases is presented a second time, each phrase being by only a textual transcription thereof. Finally, the lecture is presented again in its original form.

The primary focus of the invention is to make foreign language learning enjoyable and less of a chore, using the plethora of audio-visual presentations that are readily available in the form of movies, soap operas, news and educational programs, and even cartoons. The original purpose of the presentation is unimportant, so long as it holds the interest of the viewer.

The audio-visual method described above may be supplemented with basic grammar lessons. The short program segments form the basis for the grammar lessons, each of which is based on the dialog of a short program segment which precedes the lesson.

The audio-visual method may also be supplemented with vocabulary drills, each of which is based on the dialog of a short program segment which precedes the drill.

The audio-visual method may also be supplemented by translation drills, each of which is based on the program or short program segments.

The audio-visual method may also be supplemented by providing a workbook for use by the viewer/listener, which provides translation, grammar and vocabulary drills which are related to the program. For translation drills, individual screen shots are provided with a transcription of the associated foreign language phrase. A student is expected to translate the transcription into a second language, which is, preferably, his native language.

It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. In combination with an audio-video system having a viewing screen and sound output, an audio-visual method for learning a foreign language comprising the following steps:
showing, on the audio-video system at least a portion of a program in its original first language form, said program having both motion picture and audio components;
showing a sequence of short program segments, each segment including a single spoken phrase by one of the program participants, along with an original first language transcription and a translation of the statement in a second language;
reshowing the program in its original language form;
reshowing the sequence of short program segments, each segment including a single spoken phrase by one of the participants, along with only a transcription of each phrase; and
reshowing the program in its original language form.

2. The audio-visual method of claim 1, wherein statements made by program participants are shown as subtitles.

3. The audio-visual method of claim 1, wherein statements made by program participants are shown as dialog balloons such as those used in comic books.

4. The audio-visual method of claim 1, wherein each short program segment ends with a frozen frame, which includes a written translation and/or transcription.

5. The audio-visual method of claim 1, wherein baroque background music is played during at least a portion of presentation.

6. The audio-visual method of claim 1, wherein baroque background music is played at least during the presentation of frozen scenes or short program segments.

7. The audio-visual method of claim 1, wherein each of the short program segments includes a frozen scene with audio.

8. The audio-visual method of claim 1, which further comprises the step of providing a workbook, which provides translation, grammar and vocabulary drills which are related to the program.

9. In combination with an audio-video system having a viewing screen and sound output, an audio-visual method for learning a foreign language comprising the following steps:
presenting a program or a portion of a program in its original first language form without any text;
presenting a sequence of spoken phrases from the program, each phrase being accompanied by both a textual transcription thereof in the first language and a corresponding textual translation in a second language;
presenting again said program or program portion in its original first language form;
presenting again the sequence of spoken phrases, accompanied by a textual transcription thereof;
presenting again the program in its original first language form.

10. The audio-visual method of claim 9, wherein each spoken phrase is shown as a line of text.

11. The audio-visual method of claim 9, wherein each spoken phrase is shown as a dialog balloon, such as those used in comic books.

12. The audio-visual method of claim 9, wherein said program includes both motion picture and audio components.

13. The audio-visual method of claim 9, wherein each spoken phrase is accompanied by a frozen frame.

14. The audio-visual method of claim 9, wherein baroque background music is played during at least a portion of presentation.

15. The audio-visual method of claim 9, wherein baroque background music is played at least during the presentation of the sequence of spoken phrases.

16. The audio-visual method of claim 9, which further comprises the step of providing a workbook, which provides translation, grammar and vocabulary drills which are related to the program.

17. In combination with an audio-video system having a viewing screen and sound output, an audio-visual method for learning a foreign language comprising the following steps:
showing, on a audio-video system at least a portion of a program in its original first language form, said program having both motion picture and audio components;
showing a sequence of short program segments, each segment including a single spoken phrase by one of the program participants, along with an original first language textual transcription and a textual translation of the statement in a second language; and
showing the program in its original language form a second time.

18. The audio-visual method of learning a foreign language of claim 17, which further comprises the steps of:
showing the sequence of short program segments a second time, along with a textual transcription of each phrase; and
showing the program in its original language form a third time.

19. The audio-visual method of claim 17, wherein statements made by program participants are shown as subtitles.

20. The audio-visual method of claim 17, wherein the short program segments are used as the basis for basic grammar lessons, which are inserted between the various short program segments.
